(19) United States
(12) Patent Application Publication
(10) Pub. No.: US 2026/0171575 A1
(43) Pub. Date: Jun. 18, 2026

(54) FRAME ASSEMBLY FOR BATTERY PACK AND BATTERY PACK

(71) Applicant: FORD GLOBAL TECHNOLOGIES, LLC, Dearborn, MI (US)

(72) Inventors: Bin YIN, Jiang Su (CN); Jian LENG, Jiang Su (CN)

(21) Appl. No.: 19/415,887

(22) Filed: Dec. 11, 2025

(30) Foreign Application Priority Data
Dec. 12, 2024 (CN) 202423073165.X

(51) Int. Cl. H01M 50/244; H01M 10/658; H01M 50/242; H01M 50/249; H01M 50/291; H01M 50/507

(52) U.S. Cl. CPC H01M 50/244; H01M 10/658; H01M 50/242; H01M 50/249; H01M 50/291; H01M 50/507

(57) ABSTRACT

A frame assembly for a battery pack is provided. The frame assembly includes a main frame body having a plurality of openings spaced apart in a first direction, and a plurality of busbars disposed on the main frame body in the first direction and adjacent to the plurality of openings. A battery pack may incorporate the frame assembly. This technical solution enables a higher integration level of the battery BBM assembly, leading to increased overall battery pack performance.

### CROSS-REFERENCE TO RELATED APPLICATIONS

This disclosure claims priority to Chinese Patent Application No. 202423073165.X, which was filed on Dec. 12, 2024 and is incorporated herein by reference in its entirety.

### TECHNICAL FIELD

The present disclosure relates to the field of vehicles, and specifically to a frame assembly for a battery pack and a battery pack.

### BACKGROUND

Modern electrified vehicles are equipped with battery packs, which face increasingly stringent requirements for energy density, range, and durability, motivated by consumer demand for better vehicle performance and longer driving range.

The rapid development of battery technology has made the Busbar Module (BBM) assembly indispensable for establishing series and parallel electrical connections in the battery. In typical configurations, the battery BBM assembly is mounted onto the battery module, employs wiring harnesses for connectivity, and is supported by side plates.

It is recognized by the inventors of the present disclosure that advancing the integration level of the battery BBM assembly is critical for boosting customer satisfaction.

In view of this, there remains room for further advancements in this field of technology.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of the present disclosure recognize that there is a need for a frame assembly for a battery pack, which can enhance the integration level of the battery BBM assembly, thus increasing overall battery pack performance.

According to an aspect of the present disclosure, there is provided a frame assembly for a battery pack, comprising:
a main frame body having a plurality of openings spaced apart in a first direction; and
a plurality of busbars disposed on the main frame body in the first direction and adjacent to the plurality of openings.

According to an embodiment of the present disclosure, the busbars are integrated into the main frame body; and the main frame body further comprises a plurality of vent holes spaced apart in the first direction.

According to an embodiment of the present disclosure, the frame assembly further comprises: a thermal insulation plate comprising a main plate body and a weakened portion, wherein the thermal insulation plate extends in the first direction and overlays a first side of the main frame body.

According to an embodiment of the present disclosure, the weakened portion is sheet-shaped and is connected to the main plate body via a weakened arm, the weakened portion being aligned with the vent holes to cover at least one of them.

According to an embodiment of the present disclosure, a plurality of the weakened portions are provided, spaced apart in the first direction, each weakened portion being associated with a respective vent hole.

According to an embodiment of the present disclosure, the plurality of openings are partitioned by a plurality of spacer portions, at least one of the spacer portions is provided with one or more protrusions, the thermal insulation plate is formed with one or more holes positioned to correspond to the protrusions, and the thermal insulation plate is connected to the spacer portions by shape-fitting engagement between the holes and the protrusions and/or by thermally welding the holes to the protrusions.

According to an embodiment of the present disclosure, the main frame body is formed by injection molding, the frame assembly further comprises reinforcing members embedded in the main frame body along the first direction, and the reinforcing members have a cross-sectional shape selected from the group consisting of U-shape, C-shape, X-shape, Y-shape, I-shape, and H-shape.

According to an embodiment of the present disclosure, the frame assembly further comprises a sampling port disposed adjacent to the vent holes.

According to another aspect of the present disclosure, there is provided a frame assembly for a battery pack, comprising:
a main frame body comprising:
   a first crossbeam and a second crossbeam extending in a first direction;
   a plurality of longitudinal beams extending between the first crossbeam and the second crossbeam; and
   a plurality of openings defined between the plurality of longitudinal beams; and
a plurality of busbars disposed on the main frame body in the first direction and adjacent to the plurality of openings.

According to an embodiment of the present disclosure, the frame assembly comprises a plurality of vent holes spaced apart in the first direction and being adjacent to the first crossbeam and/or the second crossbeam.

According to yet another aspect of the present disclosure, there is provided a battery pack comprising a frame assembly, wherein the frame assembly is disposed along a lateral side of a battery array of the battery pack,
the frame assembly comprising;
a main frame body having a plurality of openings spaced apart in a first direction;
a plurality of busbars disposed on the main frame body in the first direction and adjacent to the plurality of openings;
a thermal insulation plate comprising a main plate body and a weakened portion, wherein the thermal insulation plate extends in the first direction and overlays a first side of the main frame body; and
wherein each battery cell in the battery array is electrically connected to the busbars from a second side of the main frame body via tabs disposed on lateral sides of the battery cell.

### BRIEF DESCRIPTION OF THE FIGURES

For a better understanding of the present disclosure, reference may be made to embodiments depicted in the following drawings. The components in the drawings are not necessarily to scale and related elements may be omitted, or in some instances proportions may have been exaggerated, so as to emphasize and clearly illustrate the novel features described herein. In addition, system components can be variously arranged, as is known in the art. Further in the figures, like reference numbers refer to like parts throughout the different figures.

FIG. 1 is a schematic diagram of a vehicle according to an embodiment of the present disclosure.

FIG. 2 is a schematic diagram of a battery pack according to an embodiment of the present disclosure.

FIG. 3 is a schematic diagram of a battery module according to an embodiment of the present disclosure.

FIG. 4 is a schematic diagram of a frame assembly according to an embodiment of the present disclosure.

FIG. 5 is a partially enlarged schematic diagram of a main frame body according to an embodiment of the present disclosure.

FIG. 6 is a partially enlarged schematic diagram of a thermal insulation plate of the frame assembly according to an embodiment of the present disclosure.

FIG. 7 is a cross-sectional schematic diagram of the main frame body taken along line A-A of the embodiment in FIG. 5 of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features depicted in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background above, the inventors of the present application have recognized that in the prior art, battery packs are designed in an array and mounted on battery trays. Therefore, in some designs, a plurality of independent battery modules must be arranged. After being packaged, these battery modules are usually mounted on the tray via beam structures, and must be interconnected via a large number of busbars and buses. However, arranging more beam structures to fix the battery modules results in increased complexity and a low effective space utilization rate. In view of the aforementioned deficiencies in the prior art, the inventors of this application provide, in one or more embodiments, a battery holder and a battery pack incorporating the battery holder, which is intended to address one or more deficiencies existing in the prior art.

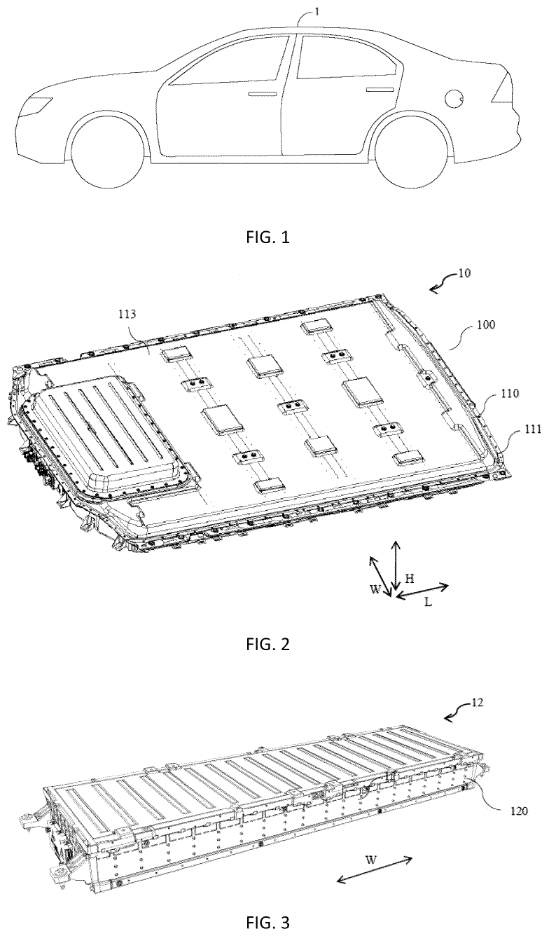

FIG. 1 is a schematic diagram of a vehicle 1 according to an embodiment of the present disclosure. The vehicle 1 may refer to any means of transportation including a battery pack, for example, it may include but not limited to fossil fuel vehicles, electric vehicles (such as plug-in hybrid electric vehicles (PHEVs), full hybrid electric vehicles (FHEVs), mild hybrid electric vehicles (MHEVs), or battery electric vehicles (BEVs), etc.), and may even include ships, aircraft, and the like. The vehicle 1 may include components related to mobility, such as an engine, an electric motor, a transmission, a suspension, a driveshaft, and/or wheels, etc. The vehicle 1 may be non-autonomous, semi-autonomous (e.g., some routine motive functions controlled by the vehicle), or autonomous (e.g., motive functions are autonomously controlled by the vehicle without direct input from the user).

FIG. 2 is a schematic diagram of a battery pack 10 according to an embodiment of the present disclosure, and FIG. 3 is a schematic diagram of a battery module 12 in the battery pack 10 according to an embodiment of the present disclosure. In the exemplary embodiments depicted in FIGS. 2 and 3, the battery pack 10 includes a battery housing assembly 100 and the battery module 12 is received in the battery housing assembly 100. The battery housing assembly 100 may include a housing 110 and various possible functional components. The housing 110 may include a tray 111 configured to support the battery module 12 and a top cover 113 configured to cover the battery module 12. The tray 111 and the top cover 113 together define a receiving cavity for receiving the battery module 12. The tray 111 may be a box-like structure with a top opening, including a bottom wall and one or more side walls extending upward from the periphery of the bottom wall. The top cover 113 covers the top opening of the tray 111. The top cover 113 may be a box-like structure with a bottom opening, including a top wall and one or more side walls extending downward from the periphery of the top wall. The top opening of the tray 111 is abutted with the bottom opening of the top cover 113, so that the housing 110 encloses a substantially enclosed receiving cavity. Flanges may be disposed at the top opening of the tray 111 and the bottom opening of the top cover 113, with mating connection structures provided on the flanges to achieve the connection between the tray 111 and the top cover 113.

Those skilled in the art can understand that the top cover and the tray may adopt alternative configurations; for example, the tray may consist solely of a bottom wall, and the top cover may include side walls extending toward the tray and connected thereto, provided that the two can collectively define a space for receiving battery cells. The housing 110 defines a length direction L, a width direction W, and a height direction H. The battery module 12 may include a plurality of battery cells 11 arranged in an array. The plurality of battery cells 11 may be arranged in multiple rows; the battery cells 11 in each row are arranged along the width direction W of the housing 110, and the multiple rows are arranged along the length direction L of the housing 110. The battery module 12 may further include a battery management unit configured to control the charging and discharging of the plurality of battery cells 11. In one or more alternative implementations, the battery cells 11 may alternatively be arranged along the length direction L.

The battery pack 10 may be applied in various scenarios. In the embodiment of the present disclosure, the battery pack 10 is applied to a vehicle. The length direction L, width direction W, and height direction H of the housing 110 may correspond respectively to the longitudinal direction (front-rear direction), lateral direction, and height direction of the vehicle.

Those skilled in the art should understand that while the battery housing assembly 100 is illustrated as receiving the battery module 12 in the above exemplary embodiments, thereby serving as a housing assembly for the integrated battery pack 10, in alternative embodiments, the battery housing assembly 100 may alternatively be configured to receive individual battery cells, thereby serving solely as a housing assembly for a simplified battery unit.

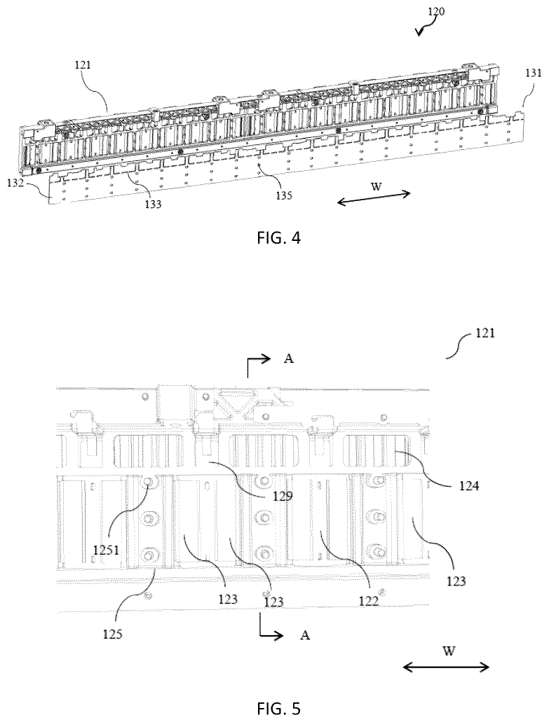

Referring to FIG. 3, in the exemplary embodiment of the battery module 12 depicted therein, the battery module 12 includes a plurality of battery cells arranged along the first direction W, and the battery module 12 is integrally received in the receiving cavity defined by the tray and the top cover of the battery pack 10 depicted in FIG. 2. A frame assembly 120 is disposed along a lateral side of the battery module 12. With reference to the schematic diagram of the frame assembly 120 in the exemplary embodiment shown in FIG. 4, the frame assembly 120 includes a main frame body 121 and a thermal insulation plate 131, both of which extend along the first direction W.

Referring to the partially enlarged schematic diagram of the main frame body 121 shown in FIG. 5, the main frame body 121 has a plurality of openings 122 spaced apart in the first direction W, a plurality of busbars 123 are disposed on the main frame body 121, and each opening 122 is partially overlayed by two spaced busbars 123. In other embodiments of the present disclosure, the plurality of busbars may be disposed adjacent to the plurality of openings. Within the specification of the present disclosure, the term “adjacent” refers to the physical proximity between two or more components, encompassing configurations wherein the components are in direct contact or wherein a gap is present therebetween. By way of example, in various embodiments of the present disclosure, a busbar may be located above, below, to the left, or to the right of an opening; it may also be partially exposed by or concealed behind the opening. The plurality of openings 122 are partitioned by a plurality of spacer portions 125. Each spacer portion 125 is provided with a plurality of protrusions 1251. In the embodiment depicted in FIG. 5, the number of the protrusions 1251 is three. It is understood that the number of the protrusions 1251 may be adjusted as needed.

In one or more embodiments of the present disclosure, the plurality of busbars 123 may be integrated into the main frame body 121. For example, they can be integrally formed with the main frame body 121 by molding or they can be integrated with the frame body 121 through methods such as bonding, welding, or fastening connections. It is understood that in other embodiments of the present disclosure, the busbars 123 may be connected to the main frame body 121 by various connection means such as bonding, welding, and fastener connection. As further shown in the exemplary embodiment of FIG. 5, the main frame body 121 is further provided with a plurality of vent holes 124 spaced apart in the first direction W and a plurality of sampling ports 129 adjacent to the vent holes 124. The sampling ports 129 facilitate Battery Management System (BMS) in acquiring real-time sampling information, including but not limited to battery voltage, charging/discharging currents, cell voltage, and battery temperature. This information is fundamental for the precise control and management operations performed by the BMS. In one or more embodiments of the present disclosure, as depicted in FIG. 7 (a cross-sectional view of the main frame body 121 taken along the direction A-A of FIG. 5), the main frame body 121 is formed by injection molding. The main frame body 121 can be made of metal materials such as steel or aluminum, or other high-strength non-metallic materials, such as glass fiber or carbon fiber reinforced plastic. During the injection molding process, reinforcing members 128 extending in the first direction W are embedded in both an upper side beam 126 and a lower side beam 127 of the main frame body 121. In the embodiment depicted in FIG. 7, the reinforcing member 128 has a C-shaped cross-section. It is to be understood that, in other embodiments, the reinforcing member may have different cross-sectional shapes, including but not limited to U-shape, X-shape, Y-shape, I-shape, and H-shape. It is further to be understood that the reinforcing members with C-shaped, U-shaped, X-shaped, Y-shaped, and H-shaped cross-sections exhibit comparatively higher structural strength than those with an I-shape cross-section. In one or more embodiments of the present disclosure, the reinforcing member 128 disposed in the main frame body 121 may be made of metal materials, such as steel, aluminum, or other high-strength materials. The reinforcing member 128 molded in the main frame body 121 can effectively enhance the overall structural strength of the main frame body 121, and the use of C-shaped, U-shaped, X-shaped, Y-shaped, I-shaped, and H-shaped cross-sections can effectively enhance the strength while maintaining the lightweight characteristic of the main frame body 121.

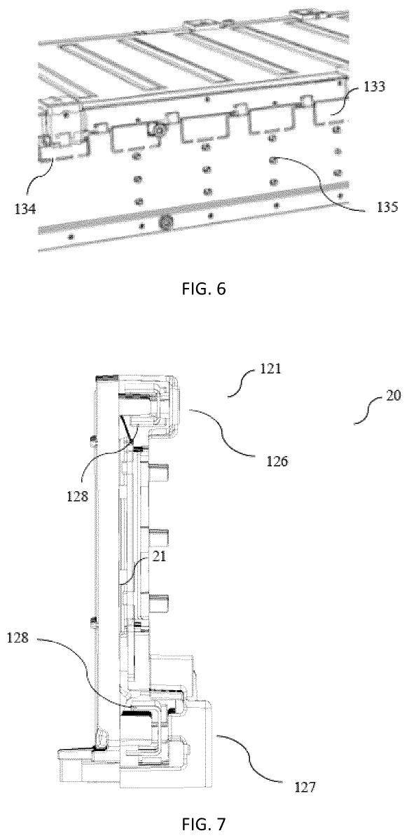

Referring next to FIG. 4, in the exemplary embodiment of the frame assembly 120 depicted therein, the thermal insulation plate 131 includes a main plate body 132 and a weakened portion 133. With reference to the partially enlarged schematic diagram of the thermal insulation plate 131 depicted in FIG. 6, the weakened portion 133 is connected to the main plate body 132 via a weakened connecting arm 134. In one or more embodiments of the present disclosure, the weakened connecting arm 134 may be implemented by removing part of the material of the thermal insulation plate 131 between the main plate body 132 and the weakened portion 133 to form a weakened connection between the two. As depicted in FIG. 6, a plurality of weakened portions 133 of the thermal insulation plate 131 may be in one-to-one correspondence with the vent holes 124 on the main frame body 121. It is understood that in other embodiments of the present disclosure, the number of the weakened portions may be set as needed, and each weakened portion may overlay one or more vent holes 124. For example, in one embodiment, the thermal insulation plate 131 may have only one weakened portion configured to overlay all the vent holes 124. As further shown in the exemplary embodiment depicted in FIG. 6, the thermal insulation plate 131 is formed with a plurality of holes 135 positioned to correspond to the plurality of protrusions 1251 on the spacer portions 125 of the main frame body 121. When connecting the thermal insulation plate 131 to the main frame body 121, thermal welding may be used. For example, the plurality of protrusions 1251 are heated to a hot-melt state, and then the thermal insulation plate 131 is abutted to the main frame body 121 from the side with the plurality of protrusions 1251, such that the plurality of protrusions 1251 and the plurality of holes 135 are welded together to realize the connection between the thermal insulation plate 131 and the main frame body 121. In alternative embodiments of the present disclosure, the thermal insulation plate 131 and the main frame body 121 may alternatively be connected via an interference fit between the plurality of protrusions 1251 and the plurality of holes 135 without thermal welding. As can be appreciated, a spare protrusion can be disposed on the spacer portion 125 to provide redundancy. During the thermal welding process that connects the main frame body 121 and the thermal insulation plate 131, the spare protrusion is spared from the heating process that melts the other protrusions. The spare protrusion can later be leveraged to reinforce the joint between the thermal insulation plate 131 and the main frame body 121 when additional connection strength is desired.

Referring next to the battery module 12 in the exemplary embodiment depicted in FIG. 3, the frame assembly 120 extends in the first direction W from a lateral side of the battery module 12 and is attached thereto from the lateral side. In the exemplary embodiment of the present disclosure, the battery cells in the battery module 12 are arranged in a stacked manner along the first direction W. Each battery cell has a tab that is arranged toward the lateral side. This allows the battery cells to be electrically coupled to the plurality of busbars 123 of the frame assembly 120 via the tabs arranged on the lateral sides. The attachment of the frame assembly 120 to the lateral side of the battery module 12 facilitates the electrical connection of the battery cells within the battery module 12 by means of the busbars 123 molded therein. The thermal insulation plate 131 serves to provide thermal resistance, thereby preventing heat generated by the battery module 12 from adversely affecting other battery modules and electronic components within the battery pack 10. Moreover, in an event where gas pressure generated by the battery module 12 attains a predefined threshold pressure, the weakened connecting arms 134 between the weakened portions 133 of the thermal insulation plate 131 and the main plate body 132 is configured to fracture under said pressure, causing the weakened portion 133 to separate from the main plate body 132. This enables the plurality of vent holes 124 on the main frame body 121 to open, allowing the gas to be rapidly vented through the vent holes 124.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only exemplary, and is not intended to imply that the disclosed scope of the embodiments of the present disclosure (including claims) is limited to these examples; and under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

1. A frame assembly for a battery pack, comprising:
a main frame body having a plurality of openings spaced apart in a first direction;
a plurality of busbars disposed on the main frame body in the first direction and adjacent to the plurality of openings; and
a thermal insulation plate connectable to the main frame body.

2. The frame assembly as recited in claim 1, wherein the plurality of busbars are integrated into the main frame body.

3. The frame assembly as recited in claim 1, wherein the main frame body includes a plurality of vent holes spaced apart in the first direction.

4. The frame assembly as recited in claim 3, comprising a sampling port disposed adjacent to at least a portion of the plurality of vent holes.

5. The frame assembly as recited in claim 1, wherein the thermal insulation plate extends in the first direction and overlays a first side of the main frame body.

6. The frame assembly as recited in claim 1, wherein the thermal insulation plate includes a main plate body and a weakened portion.

7. The frame assembly as recited in claim 6, wherein the weakened portion is sheet-shaped and is connected to the main plate body via a weakened arm.

8. The frame assembly as recited in claim 6, wherein the weakened portion is positioned to cover a vent hole of the main frame body.

9. The frame assembly as recited in claim 6, wherein the thermal insulation plate includes a plurality of the weakened portions that are spaced apart in the first direction, and each weakened portion of the plurality of weakened portions is positioned to cover a vent hole of the main frame body.

10. The frame assembly as recited in claim 1, wherein the main frame body includes a spacer portion that is arranged between a first opening and a second opening of the plurality of openings.

11. The frame assembly as recited in claim 10, wherein the spacer portion includes one or more protrusions that are configured to be received within corresponding holes of the thermal insulation plate for connecting the thermal insulation plate to the main frame body.

12. The frame assembly as recited in claim 11, wherein the thermal insulation plate is connected to the spacer portion by shape-fitting engagement between the corresponding holes and the one or more protrusions.

13. The frame assembly as recited in claim 11, wherein the thermal insulation plate is connected to the spacer portion by thermally welding the one or more protrusions.

14. The frame assembly as recited in claim 1, wherein the main frame body is an injection molded frame body that includes reinforcing members embedded in the main frame body along the first direction.

15. The frame assembly as recited in claim 14, wherein each of the reinforcing members includes a U-shape, C-shape, X-shape, Y-shape, I-shape, or H-shape.

16. A battery pack, comprising:
a battery array;
a frame assembly disposed along a lateral side of the battery array, wherein the frame assembly includes:
a main frame body having an opening and a vent hole above the opening; and
a thermal insulation plate connectable to the main frame body and including a main plate body and a weakened portion that is configured to separate from the main plate body to expose the vent hole when a gas pressure generated by the battery array attains a predefined threshold pressure.

17. The battery pack as recited in claim 16, wherein the frame assembly includes a busbar disposed on the main frame body adjacent to the opening.

18. The battery pack as recited in claim 16, wherein the weakened portion is connected to the main plate body by a weakened connecting arm.

19. The battery pack as recited in claim 16, wherein the main frame body includes an upper side beam, a first reinforcing member embedded in the upper side beam, a lower side beam, and a second reinforcing member embedded in the lower side beam.

20. The battery pack as recited in claim 16, wherein the main frame body includes a protrusion that is received through a mounting hole of the thermal insulation plate to connect the thermal insulation plate relative to the main frame body.
